(19) United States
(12) Patent Application Publication
(10) Pub. No.: US 2020/0269880 A1
(43) Pub. Date: Aug. 27, 2020

(54) MOBILE-BODY INFORMATION ACQUIRING SYSTEM, MOBILE-BODY INFORMATION ACQUIRING METHOD, PROGRAM, AND MOBILE BODY

(71) Applicant: HONDA MOTOR CO., LTD., MINATO-KU, TOKYO (JP)

(72) Inventor: Kaname TOKITA, WAKO-SHI, SAITAMA (JP)

(21) Appl. No.: 16/646,727

(22) PCT Filed: Sep. 10, 2018
(86) PCT No.: PCT/JP2018/033373

§ 371 Date: Mar. 12, 2020

(30) Foreign Application Priority Data
Sep. 14, 2017 (JP) 2017-176950

(51) Int. Cl. B60W 60/00; G08G 1/01; G06K 9/00

(52) U.S. Cl. CPC B60W 60/00272; B60W 2556/65; G06K 9/00798; G08G 1/0112

(57) ABSTRACT

The purpose of the present invention is to provide a mobile-body information acquiring system, a mobile-body information acquiring method, a program, and a mobile body, with which accuracy of information acquired by a mobile body serving as a subject can be improved. Provided is a mobile-body information acquiring system wherein: a calculation unit has a processing unit for setting a time point or a time when a first mobile body 1-1 desires to take action about movement or a time point or a time in the very near future that the first mobile body 1-1 desires to know in relation to movement; and a communication unit transmits information related to a time point or a time including time point information expressed by absolute time points.

### TECHNICAL FIELD

The present invention relates to a mobile-body information acquiring system, a mobile-body information acquiring method, a program, and a mobile body provided with the mobile-body information acquiring system.

### BACKGROUND ART

In the related art, there is known a technology that enables an automatic traveling vehicle to smoothly merge at a merging portion between a main line and a branch line of a road (for example, refer to Patent Document 1). When a host vehicle that is an automatic traveling vehicle that travels in the branch line approaches the merging portion with the main line, inter-vehicle communication with other vehicles which travel in the main line is performed, data of mutual vehicle positions and vehicle speeds is exchanged, and determination is made on a vehicle (specific vehicle) that is in front of the junction among the other vehicles which travel in the main line at a merging time point at which the host vehicle is predicted to reach the merging portion. Next, a distance between the specific vehicle and the merging portion at the merging time point is estimated, and the host vehicle merges at the front of the specific vehicle when the distance is equal to or greater than a predetermined value and merges at the rear of the specific vehicle when the distance is less than the predetermined value.

On the other hand, among the vehicles which travel in the main line, a vehicle that is the following vehicle of the vehicle merging from the branch line decelerates in advance before the merging to widen an inter-vehicle distance with a preceding vehicle and fixes a vehicle speed to allow the vehicle that travels in the branch line to easily merge.

In addition, there is known a technology in which position data is included in a communication protocol to provide an inter-vehicle communication device capable of receiving only what is necessary for a host vehicle (for example, refer to Patent Document 2). With regard to the inter-vehicle communication device, in one vehicle, a future predicted position is calculated, compiles the predicted position in a packet, and transmits data in a communication pattern (for example, a PN sequence) based on time and a position of each packet. Other vehicles calculate an own predicted position, generates a communication pattern based on the predicted position, and receives data by using the communication pattern. According to this, data related to an own future position can be selectively received.
Patent Document 1: Japanese Unexamined Patent Application, Publication No. H10-320691
Patent Document 2: Japanese Unexamined Patent Application, Publication No. 2000-269886

### DISCLOSURE OF THE INVENTION

### Problems to be Solved by the Invention

However, in the technology described in Patent Document 1, only a vehicle's position at a merging time point is estimated, and details thereof is not clear. In addition, in the technology described in examples of Patent Document 2, a future position is estimated through information exchange by communication in which a plurality of packets are compiled, but the estimation is based on a current time point, and thus it cannot be said that the technology is optimal for increasing accuracy of information.

The invention has been made in consideration of such circumstances, and an object thereof is to provide a mobile-body information acquiring system, a mobile-body information acquiring method, a program, and a mobile body which are capable of improving accuracy of information acquired by a mobile body serving as a subject.

### Means for Solving the Problems

To accomplish the object, according to an aspect of the invention, there is provided a mobile-body information acquiring system that exchanges information between mobile bodies (for example, vehicles 1 to be described later) including a movement unit (for example, a movement device 20 to be described later) for movement, a calculation unit (for example, a calculation unit 11 to be described later) that performs calculation relating to the movement, and a communication unit (for example, a communication unit 30 to be described later) that moves in combination with the movement unit and performs communication of an output from the calculation unit as information. The calculation unit includes a processing unit (for example, a processing unit 111 to be described later) that sets a time point or time at which a first mobile body (for example, a subject vehicle 1-1 to be described later) desires to take an action about movement or a time point or time (for example, T, T1 to T4 to be described later) in the very near future which the first mobile body desires to know in relation to movement, and the communication unit transmits information of the time point or the time which includes time point information expressed by an absolute time point.

In the invention, the calculation unit includes the processing unit that sets a time point or time at which the first mobile body desires to take an action about movement, or a time point or time in the very near future which the first mobile body desires to know in relation to movement, and the communication unit transmits information of a time point or time including time point information expressed by the absolute time point. According to this, it is possible to raise accuracy of information that the first mobile body desires to obtain such as a position of a second mobile body at time in the very near future.

It is preferable that the time point or the time that is transmitted by the communication unit is a time point after predetermined time from a current time point or a transmission time point.

In the invention, the time point or time that is transmitted by the communication unit is a time point after predetermined time from a current time point or a transmission time point. According to this, consideration can be made on time necessary for information exchange between the first mobile body and the second mobile body, and thus it is possible to realize a reduction of load on calculation processing in the first mobile body and the second mobile body.

It is preferable that the time point or the time that is set by the processing unit includes a plurality of time points or a plurality of kinds of time in the future which are closer to the present in comparison to a time point or time at which the first mobile body desires to take an action about movement, or a time point or time in the very near future which the first mobile body desires to know in relation to movement.

In the invention, the definition time point that is set by the processing unit includes a plurality of time points or a plurality of kinds of time in the future which are closer to the present in comparison to a time point or time at which the first mobile body desires to take an action about movement, or a time point or time in the very near future which the first mobile body desires to know in relation to movement. According to this, since an arbitrary time point is set, the first mobile body can obtain information such as a position of the second mobile body at a plurality of time points without limitation to one time point that is a time point in the very near future which a requester desires to know, for example, a lane change time point (merging time point). Accordingly, it is possible to obtain a calculation result with higher accuracy.

It is preferable that the communication unit transmits information of at least two or more time points or two or more kinds of time among the plurality of time points or the plurality of kinds of time which are set through communication performed once.

In the invention, the communication unit transmits information of at least two or more time points or two or more kinds of time among the plurality of time points or the plurality of kinds of time which are set through communication performed once. According to this, when information request performed once is transmitted, transmission and reception of a plurality of pieces of time point information are performed. Accordingly, it is possible to raise the degree of expectation for reply from the second mobile body in the first mobile body.

In addition, to accomplish the object, according to an aspect of the invention, there is provided a mobile-body information acquiring system that exchanges information between mobile bodies including a communication unit and a movement unit. The mobile-body information acquiring system includes: a reception unit (for example, a reception unit 312 to be described later) that receives a time point or time at which a first mobile body desires to take an action about movement or a time point or time in the very near future which the first mobile body desires to know in relation to movement as information; a calculation unit that calculates the information relating to movement of a second mobile body on the basis of the time point or time; and a transmission unit (for example, a transmission unit 311 to be described later) that transmits information of a calculation result obtained by the calculation unit to the first mobile body. The information that is transmitted to the first mobile body includes time point information expressed by an absolute time point.

In the invention, the second mobile body receives a time point or time at which the first mobile body desires to take an action about movement or a time point or time in the very near future which the first mobile body desires to know in relation to movement as information, and calculates information relating to movement of the second mobile body on the basis of the time point or time.

According to this, information such as a position of the second mobile body is calculated in the second mobile body, and thus accuracy of a calculation (simulation) result in the second mobile body is higher in comparison to an estimation result of the first mobile body. In addition, in the second mobile body, the entire volume of calculation requested from the first mobile body is obtained when the information request is made. According to this, in the second mobile body, it is possible to efficiently allocate resources relating to the calculation. In addition, it is possible to perform calculation with calculation processing capability that is possible in the second mobile body. As a result, calculation processing with less load is performed in each mobile body, and the second mobile body can transmit position information with high accuracy, and the like to the first mobile body. In addition, since the information transmitted from the second mobile body to the first mobile body includes the time point information expressed by UNIX (registered trademark) time, in a plurality of pieces of position information acquired by respective mobile bodies, definition time points match each other with high accuracy, and thus in the first mobile body, it is possible to acquire position information without performing additional calculation.

In addition, to accomplish the object, according to an aspect of the invention, there is provided a mobile-body information acquiring method of exchanging information between mobile bodies including a movement unit for movement, a calculation unit that performs calculation relating to the movement, and a communication unit that moves in combination with the movement unit and performs communication of an output from the calculation unit as information. The mobile-body information acquiring method includes: a process of setting a time point or time at which a first mobile body desires to take an action about movement or a time point or time in the very near future which the first mobile body desires to know in relation to movement by a processing unit provided in the calculation unit; and a process of transmitting information of the time point or the time which includes time point information expressed by an absolute time point by the communication unit.

In the invention, the processing unit sets a time point or time at which the first mobile body desires to take an action about movement or a time point or time in the very near future which the first mobile body desires to know in relation to movement, and the communication unit transmits information of the time point or the time which includes time point information expressed by an absolute time point. According to this, it is possible to raise accuracy of information that the first mobile body desires to obtain such as a position of a second mobile body at time in the very near future.

In addition, to accomplish the object, according to an aspect of the invention, there is provided a program that causes mobile bodies to function as a mobile-body information acquiring apparatus that exchanges information between the mobile bodies including a movement unit for movement, a calculation unit that performs calculation relating to the movement, a communication unit that moves in combination with the movement unit and performs communication of an output from the calculation unit as information, and a computer that controls the movement unit, the calculation unit, and the communication unit. The calculation unit is caused to function as a processing unit that sets a time point or time at which a first mobile body desires to take an action about movement or a time point or time in the very near future which the first mobile body desires to know in relation to movement, and the communication unit is caused to function to transmit information of the time point or the time which includes time point information expressed by an absolute time point.

In the invention, the processing unit sets a time point or time at which the first mobile body desires to take an action about movement or a time point or time in the very near future which the first mobile body desires to know in relation to movement, and the communication unit transmits information of the time point or the time which includes time point information expressed by an absolute time point. According to this, it is possible to raise accuracy of information that the first mobile body desires to obtain such as a position of a second mobile body at time in the very near future.

In addition, to accomplish the object, according to an aspect of the invention, there is provided a mobile body including: a mobile-body information acquiring system that exchanges information between mobile bodies including a movement unit for movement, a calculation unit that performs calculation relating to the movement, and a communication unit that moves in combination with the movement unit and performs communication of an output from the calculation unit as information. The calculation unit includes a processing unit that sets a time point or time at which a first mobile body desires to take an action about movement or a time point or time in the very near future which the first mobile body desires to know in relation to movement, and the communication unit transmits information of the time point or the time which includes time point information expressed by an absolute time point.

In the invention, the processing unit includes the processing unit that sets a time point or time at which the first mobile body desires to take an action about movement or a time point or time in the very near future which the first mobile body desires to know in relation to movement, and the communication unit transmits information of the time point or the time which includes time point information expressed by an absolute time point. According to this, it is possible to raise accuracy of information that the first mobile body desires to obtain such as a position of a second mobile body at time in the very near future.

### Effects of the Invention

According to the invention, it is possible to provide a system capable of improving accuracy of information acquired by a mobile body serving as a subject.

### BRIEF DESCRIPTION OF THE DRAWINGS

FIG. 1 is a block diagram illustrating a mobile body in a mobile-body information acquiring system according to an embodiment of the invention.

FIG. 2 is a conceptual diagram illustrating a preparation region and a synchronization region based on time in the mobile-body information acquiring system according to the embodiment.

FIG. 3 is a conceptual diagram illustrating a positional relationship between a subject vehicle and a nearby vehicle at a definition time point in the mobile-body information acquiring system according to the embodiment.

FIG. 4 is a conceptual diagram illustrating a positional relationship corresponding to a plurality of definition time points between the subject vehicle and the nearby vehicle in the mobile-body information acquiring system according to the embodiment.

FIG. 5 is a flowchart illustrating a mobile-body information acquiring method according to the embodiment.

FIG. 6 is a conceptual diagram illustrating a preparation region and a synchronization region based on time in a mobile-body information acquiring system according to a modification example of the embodiment.

### PREFERRED MODE FOR CARRYING OUT THE INVENTION

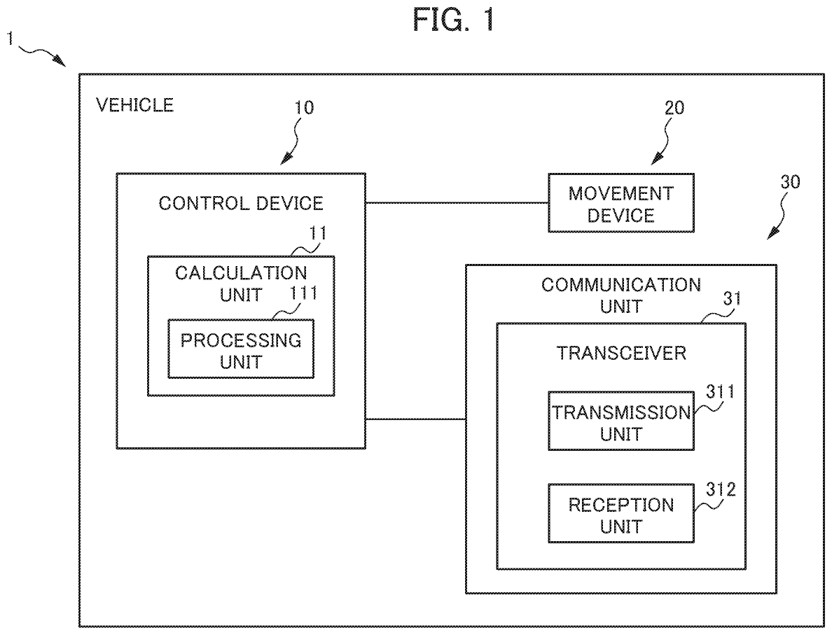

Hereinafter, an embodiment of the invention will be described in detail with reference to the accompanying drawings. FIG. 1 is a block diagram illustrating a mobile body in a mobile-body information acquiring system according to an embodiment of the invention.

The mobile-body information acquiring system is a system that performs simulation of a vehicle 1 that uses inter-vehicle communication for determining whether or not an action is possible when the vehicle 1 desires to take a predetermined action. That is, specifically, the mobile body including the mobile-body information acquiring system is the vehicle 1, and as illustrated in FIG. 1, the mobile-body information acquiring system includes a control device 10, a movement device 20 as movement unit for movement, and a communication unit 30 including a transceiver 31 provided with a transmission unit 311 and a reception unit 312.

The movement device 20 is constituted by a device for moving the vehicle 1 such as a four-wheeled vehicle. Specifically, the movement device 20 includes a power source such as an electric motor and an internal combustion engine, wheels (front wheels and rear wheels), a transmission, a steering device, a braking device, a vehicle body that supports the components, and the like which constitutes the vehicle 1. The vehicle body includes a vehicle room for occupants, and the mobile-body information acquiring system and an interface with the occupants, for example, an input and output device are provided in the vehicle room.

The control device 10 is constituted by an electronic control unit (hereinafter, referred to as “ECU”) (not illustrated) that controls the movement device 20. The control device 10 includes a calculation unit 11. The calculation unit 11 performs calculation relating to movement of the vehicle 1. Specifically, the calculation unit 11 includes a processing unit 111 connected to a storage medium (not illustrated) that stores a program or the like, and in a case where a host vehicle corresponds to a vehicle serving as a first mobile body (hereinafter, referred to as “subject vehicle 1-1”), the processing unit 111 sets a time point or time at which the host vehicle desires to take an action about movement, or a time point or time in the very near future which the host vehicle desires to know in relation to movement (hereinafter, “time point or time” will also be referred to as “definition time point”. In addition, for example, “action about movement” represents lane change (merging) when the host vehicle is travelling on a two-lane road, and the like. In addition, “time point or time in the very near future which the vehicle desires to know in relation to movement” is a definition time point in the very near future with respect to a current time point (C), and represents a definition time point at which the host vehicle moves to a predetermined position.

The definition time point that is set by the processing unit 111 includes a plurality of future definition time points closer to the present in comparison to a time point or time in the very near future at which the host vehicle desires to take an action about movement, or a time point or time which the host vehicle desires to know in relation to movement. Specifically, for example, the definition time point includes time points after three seconds, four seconds, five seconds, and six seconds from a current time point. The definition time point is set by the processing unit 111 in consideration of a preparation region P to be described later.

In addition, in a case where another vehicle 1-2 other than the subject vehicle 1-1 corresponds to the first mobile body, the processing unit 111 calculates information relating to movement of a mobile body that is a host vehicle as a second mobile body on the basis of a time point or time at which the other vehicle 1-2 desires to take an action about movement, or a time point or time in the very near future which the other vehicle 1-2 desires to know in relation to movement. Specifically, the processing unit 111 performs calculation to understand that the host vehicle is travelling at which position of a lane at the definition time point.

Here, a configuration of the mobile-body information acquiring system in the subject vehicle 1-1 and a configuration of the mobile-body information acquiring system in the other vehicle 1-2 are the same as each other. Accordingly, in correspondence with a situation of a vehicle on the road, an arbitrary vehicle including the mobile-body information acquiring system may be any of the subject vehicle 1-1 or the other vehicle 1-2.

The communication unit 30 is configured to transmit a result output from calculation by the calculation unit 11 as information. Specifically, the communication unit 30 includes the transceiver 31. The transmission unit 311 of the transceiver 31 of the subject vehicle 1-1 transmits the information of the calculation result obtained by the calculation unit 11 to the other vehicle 1-2. The reception unit 312 receives a time point or time at which the other vehicle 1-2 desires to take an action about movement, or a time point or time in the very near future which the other vehicle 1-2 desires to know in relation to movement as information.

Time point information handled as data in the communication unit 30 is expressed by an absolute time point. Here, the absolute time point represents a time point that can be shared with extremely high accuracy such as a time point expressed as formal elapsed seconds (inserted leaf seconds are subtracted from substantial elapsed seconds, and deleted leaf seconds are added) from a predetermined time point in coordinated universal time (UTC). In this embodiment, as the absolute time point, for example, UNIX (registered trademark) time can be used, but other absolute time points may be used.

In addition, the “definition time point” is a future time point after predetermined time from a current time point or a time point at which the communication unit 30 performs the transmission. As described above, in a case where a plurality of the definition time points are set, the communication unit 30 transmits information of at least two or more definition time points among the plurality of definition time points which are set through inter-vehicle communication performed once (transmission performed once and reception performed once).

Next, description will be given of a mobile-body information acquiring method that is performed by using the mobile-body information acquiring system. In the following mobile-body information acquiring method, description will be given with reference to an example in which lane change is performed as an action of the subject vehicle 1-1.

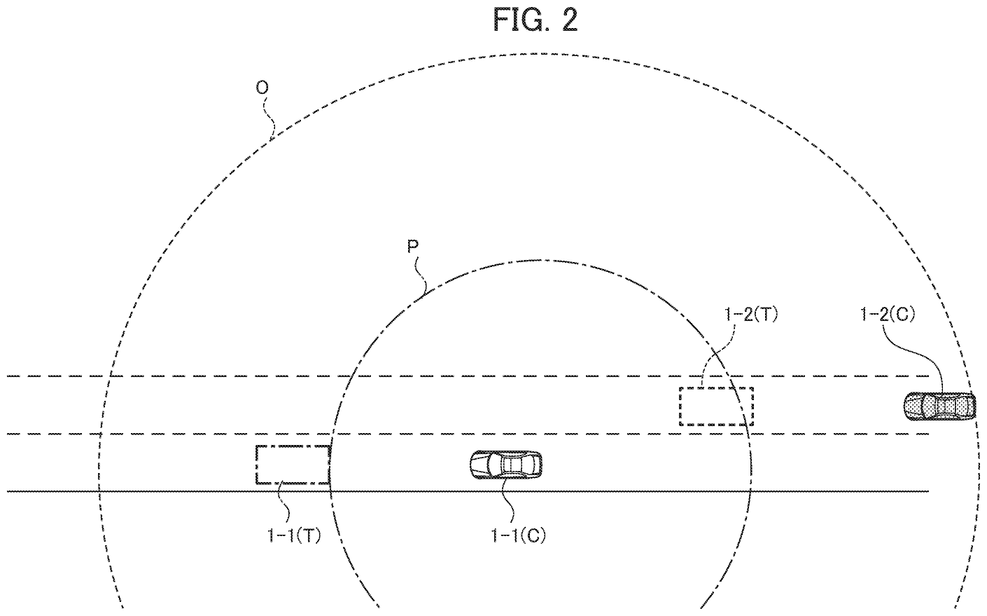

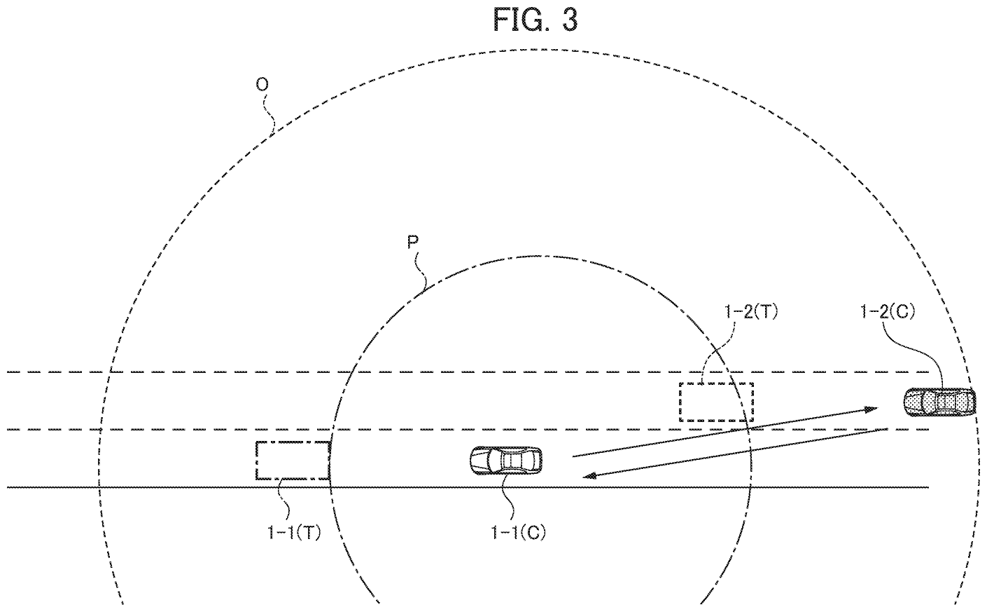

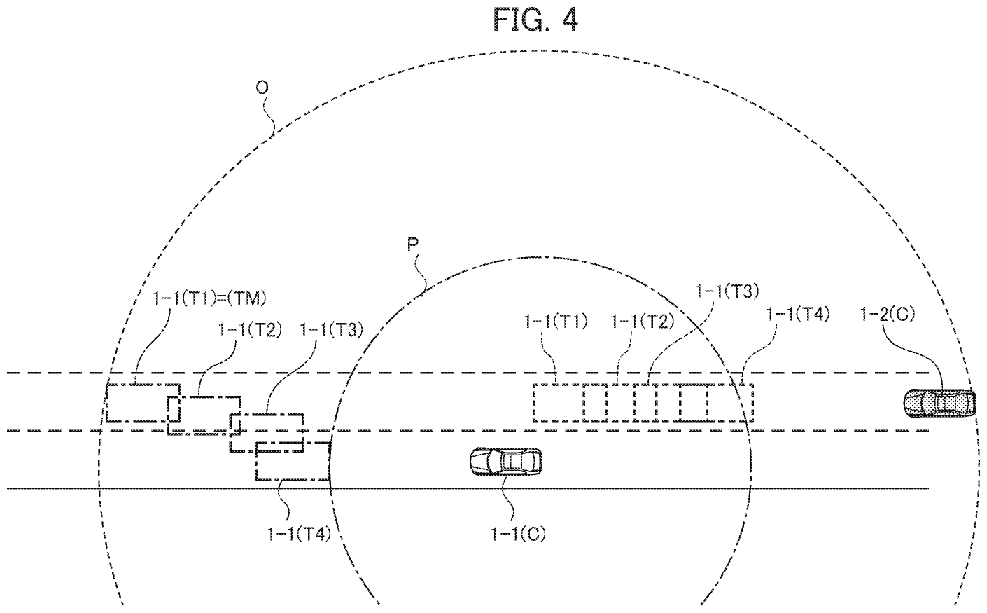

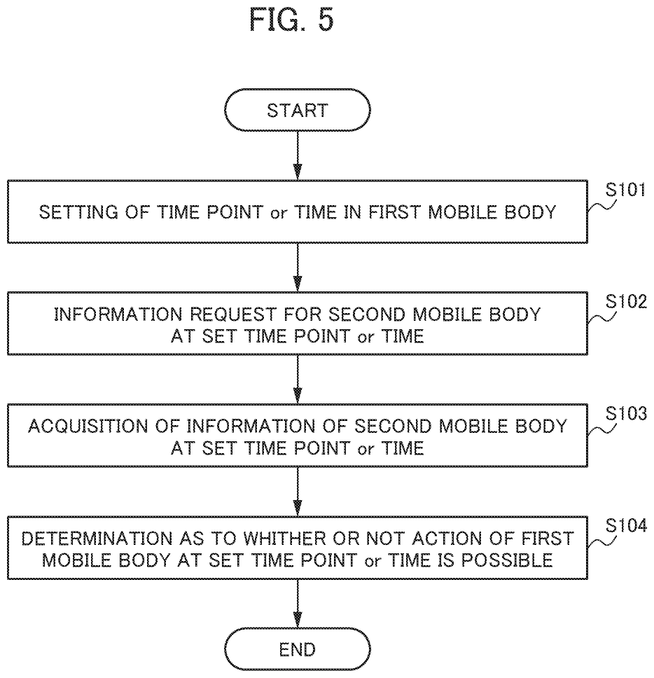

First, the definition time point that is set will be described. FIG. 2 is a conceptual diagram illustrating a preparation region and a synchronization region based on time in the mobile-body information acquiring system according to the embodiment of the invention. FIG. 3 is a conceptual diagram illustrating a positional relationship between a subject vehicle and a nearby vehicle at a definition time point in the mobile-body information acquiring system according to the embodiment of the invention. FIG. 4 is a conceptual diagram illustrating a positional relationship corresponding to a plurality of definition time points between the subject vehicle and the nearby vehicle in the mobile-body information acquiring system according to the embodiment of the invention. FIG. 5 is a flowchart illustrating the mobile-body information acquiring method according to the embodiment of the invention.

As illustrated in FIG. 2, a preparation region P and a synchronization region O which are two time regions are defined with respect to a current time point 1-1(C) in the subject vehicle 1-1. The preparation region P is a region of a time point closer to a current time point (in FIG. 2, a time point at which the subject vehicle 1-1 exists at a position of a subject vehicle 1-1(C). Hereinafter, the current time point is referred to as “current time point (C)”), and the synchronization region O is a time point region farther from the current time point (C) in comparison to the preparation region P. For example, an outer peripheral edge of the preparation region P has a time difference of five seconds from the current time point (C), and an outer peripheral edge of the synchronization region O has a time difference of ten seconds from the current time point (C). Accordingly, for example, in a case where the subject vehicle 1-1 is traveling at 100 km/h, a distance from the subject vehicle 1-1 to the outer peripheral edge of the synchronization region O is approximately 300 m.

In the mobile-body information acquiring method, first, the subject vehicle 1-1(C) performs communication another vehicle 1-2(C) as a second mobile body in the preparation region P, and updates information such as a positional relationship relating to a nearby region of the subject vehicle 1-1(C). Data acquisition is initiated by a driver's operation, and may be an operation of an indicator such as a winker, or a voice command of utterance. Alternatively, the acquisition is initiated in accordance with determination by a driving control unit in automatic driving. Specifically, with regard to processing by the processing unit 111 of the control device 10 in the subject vehicle 1-1(C), in step S101 of the flowchart illustrated in FIG. 5, a definition time point T in the synchronization region O is generated as illustrated in FIG. 2 and FIG. 4 to make an information request for another vehicle 1-2. For example, the definition time point T is set to “time point after three seconds from the current time point (C) in UNIX (registered trademark) time (refer to FIG. 2 or the like)”, or a plurality of the definition time points T such as “time point (T4) after three seconds from the current time point (C) in UNIX (registered trademark) time”, “time point (T3) after four seconds from the current time point (C) in UNIX (registered trademark) time”, “time point (T2) after five seconds from the current time point (C) in UNIX (registered trademark) time”, and “time point (T1) after six seconds from the current time point (C) in UNIX (registered trademark) time” are set (refer to FIG. 4 or the like). Note that, in FIG. 2 to FIG. 4, it is preferable that a position of the subject vehicle 1-1 or the other vehicle 1-2 as indicated by a virtual line is based on an external shape in consideration of a longitudinal length and a lateral width of a vehicle, but the position may be based on a position sensor for simplification of calculation processing, or may be a front edge position or a rear edge position of the vehicle or a combination thereof.

In a case of generating a plurality of definition time points as described above, among the definition time points, one definition time point (T) is a time point (hereinafter, referred to as a merging time point (TM)) at which lane change as an action performed by the subject vehicle 1-1 is carried out, and a definition time point is set also in a time point between the merging time point (TM) and the current time point (C). For example, in a case where “time point after six seconds in UNIX (registered trademark) time” is the definition time point (merging time point (TM)) of a time point at which the lane change as the action performed by the subject vehicle 1-1 is carried out, three definition time points including “time point (T4) after three seconds from the current time point (C) in UNIX (registered trademark) time”, “time point (T3) after four seconds from the current time point (C) in UNIX (registered trademark) time”, and “time point (T2) after five seconds from the current time point (C) in UNIX (registered trademark) time” are the definition time points between the merging time point (TM) and the current time point (C). In addition, the processing unit 111 generates position information of the subject vehicle 1-1 at the definition time points which are set. Alternatively, the definition time point can be set in an inverse operation manner from an arbitrary time point in relation to an action in the synchronization region of the subject vehicle 1-1.

The definition time point is determined on the basis of a vehicle speed of the subject vehicle 1-1(C), or time or a distance defined in the enforcement ordinance of the road traffic law, or the like. Accordingly, the definition time point varies in correspondence with a situation instead of an always constant time point relative to the current time (C) such as “time point after six seconds from the current time (C) in UNIX (registered trademark) time”. As a result, a range of the preparation region P and a range of the synchronization region O also flexibly vary in correspondence with the situation. The control device 10 in the subject vehicle 1-1 executes steps S101 to S104 of the flowchart illustrated in FIG. 5 in the preparation region P, and lane change that is an action of the subject vehicle 1-1 is actually carried out in the synchronization region O (for time from the outer peripheral edge of the preparation region P to an outer edge portion of the synchronization region O). In addition, the processing by the control device 10 in the subject vehicle 1-1(C) proceeds to step S102.

Next, the subject vehicle 1-1(C) makes an information request by transmitting information accompanied with a definition time point to the other vehicle 1-2(C). Specifically, in step S102, the control device 10 of the subject vehicle 1-1(C) performs control with respect to the communication unit 30 to transmit information including the set definition time point expressed by UNIX (registered trademark) time to the other vehicle 1-2(C).

In contrast, the reception unit 312 of the transceiver 31 of the other vehicle 1-2(C) receives information including the definition time point from the subject vehicle 1-1(C). In addition, the calculation unit 11 of the control device 10 of the other vehicle 1-2(C) calculates and generates position information of the other vehicle 1-2(C) at the received definition time point. In addition, the transmission unit 311 of the transceiver 31 of the other vehicle 1-2(C) transmits information of the calculation result obtained by the calculation unit 11 to the subject vehicle 1-1(C).

Next, with regard to the processing by the processing unit 111 of the control device 10 in the subject vehicle 1-1(C), in step S103 of the flowchart illustrated in FIG. 5, position information relating to other vehicles 1-2 (C, T, and T1 to T4) is acquired, and a positional relationship with subject vehicles 1-1 (C, T, and T1 to T4) is calculated. In addition, the processing by the control device 10 in the subject vehicle 1-1(C) proceeds to step S104.

Next, in step S104, the control device 10 in the subject vehicle 1-1(C) evaluates the positional relationship between the subject vehicles 1-1 (C, T, and T1 to T4) and other vehicles 1-2 (C, T, T1 to T4), and determines whether or not to execute a driving plan for lane change. Specifically, in a case where only one definition time (T) is set, as illustrated in FIG. 3, the control device 10 determines whether or not the subject vehicle 1-1 can perform lane change in such a manner that the subject vehicle 1-1 and the other vehicle 1-2 are safe at time from the outer peripheral edge of the preparation region P to the outer edge portion of the synchronization region O on the basis of the positional relationship between the subject vehicle 1-1 and the other vehicle 1-2 at the definition time (T). A driver of the subject vehicle 1-1 is notified of the determination by an interface of the system in the vehicle room.

In addition, in a case where a plurality of kinds of the definition time (T1 to T4) are set, as illustrated in FIG. 4, the control device 10 determines whether or not a subject vehicle can perform lane change in such a manner that the subject vehicle 1-1 and the other vehicle 1-2 are safe at time from the outer peripheral edge of the preparation region P to the outer edge portion of the synchronization region O on the basis of the positional relationship between the subject vehicle 1-1 and the other vehicle 1-2 at the plurality of kinds of definition time (T1 to T4). Hereinbefore, the mobile-body information acquiring method has been described, and the subject vehicle 1-1 carries out lane change or travels as is in a currently traveling lane without carrying out lane change on the basis of the determination. Position information relating to the same definition time point is shared between the subject vehicle 1-1 and the other vehicle 1-2, and thus adjustment of an action of any one or both of the vehicles is easily performed. In this embodiment, the lane change action is understood by a positional relationship with a lane. For example, a vehicle stays in the same lane at a time point of action initiation (T4), the vehicle crosses the lane by approximately the half or less of a vehicle width at a time point in the middle of the action (T3), the vehicle crosses the lane by approximately the half or greater of the vehicle width at a time point in the middle of the action (T2), and movement to a desired lane is completed at a time point of action completion (T1).

According to this embodiment, the following effect is obtained. In this embodiment, the calculation unit 11 includes the processing unit 111 that sets a time point or time at which the subject vehicle 1-1 as a first mobile body desires to take an action (lane change) about movement, or a time point or time in the very near future which the subject vehicle 1-1 desires to know in relation to movement. The communication unit 30 transmits information of a time point or time including time point information expressed by an absolute time point. According to this, it is possible to raise accuracy of information that the subject vehicle 1-1 desires to obtain such as a position of the other vehicle 1-2 at definition time (T, T1 to T4) in the very near future.

In addition, the definition time point (T, T1 to T4) transmitted by the communication unit 30 is a time point after predetermined time from the current time point (C). According to this, consideration can be made on time necessary for information exchange between the subject vehicle 1-1 and the other vehicle 1-2, and thus it is possible to realize a reduction of load on calculation processing in the subject vehicle 1-1 and the other vehicle 1-2.

In addition, the definition time point that is set by the processing unit 111 includes a plurality of time points or a plurality of kinds of time in the future which are closer to the present in comparison to a time point or time at which the subject vehicle 1-1 desires to take an action about movement, or a time point or time in the very near future which the first mobile body desires to know in relation to movement. According to this, since an arbitrary time point is set as the definition time point, the subject vehicle 1-1 can obtain information such as a position of the other vehicle 1-2 at a plurality of the definition time points without limitation to one time point that is a lane change time point (merging time point (TM)) that is a time point in the very near future which a requester desires to know. Accordingly, it is possible to obtain a calculation result with higher accuracy. Note that, it is possible to designate time or a time point in the past to the definition time point as necessary.

In addition, the communication unit 30 transmits information of at least two or more time points (T1 to T4) or two or more kinds of time among the plurality of definition time points which are set through communication performed once. According to this, when information request performed once is transmitted, transmission and reception of a plurality of pieces of time point information are performed. Accordingly, it is possible to raise the degree of expectation for reply from the other vehicle 1-2 in the subject vehicle 1-1.

In addition, the mobile-body information acquiring system according to this embodiment includes the reception unit 312 that receives a time point or time at which the subject vehicle 1-1 desires to take an action about movement, or a time point or time in the very near future which the subject vehicle 1-1 desires to know in relation to movement as information, the calculation unit 11 that calculates information relating to movement of another vehicle 1-2 as a second mobile body on the basis of the time point or time, and the transmission unit 311 that transmits information of a calculation result obtained by the calculation unit 11 to the subject vehicle 1-1. The information transmitted to the subject vehicle 1-1 includes time point information expressed by UNIX (registered trademark) time. The UNIX (registered trademark) time can be acquired by various methods, but may be acquired from the outside, and can be acquired, for example, by performing processing a difference from global positioning system (GPS) time. A problem of overflow of digits of the GPS clock is solved when employing the UNIX (registered trademark) time.

Accordingly, information such as a position of the other vehicle 1-2 is calculated in the other vehicle 1-2, and thus accuracy of a calculation (simulation) result in the other vehicle 1-2 is higher in comparison to an estimation result of the subject vehicle 1-1. In addition, in the other vehicle 1-2, the entire volume of calculation requested from the subject vehicle 1-1 is obtained when the information request is made. According to this, in the other vehicle 1-2, it is possible to efficiently allocate resources relating to the calculation. In addition, it is possible to perform calculation with calculation processing capability that is possible in the other vehicle 1-2. As a result, calculation processing with less load is performed in each vehicle, and the other vehicle 1-2 can transmit position information with high accuracy, and the like to the subject vehicle 1-1. In addition, since the information transmitted from the other vehicle 1-2 to the subject vehicle 1-1 includes the time point information expressed by UNIX (registered trademark) time, in a plurality of pieces of position information acquired by respective vehicles, definition time points match each other with high accuracy, and thus in the subject vehicle 1-1, it is possible to acquire position information without performing additional calculation.

Note that, it should be understood that the invention is not limited to the above-described embodiment, and modifications, improvements, and the like in a range capable of accomplishing the object of the invention are included in the invention.

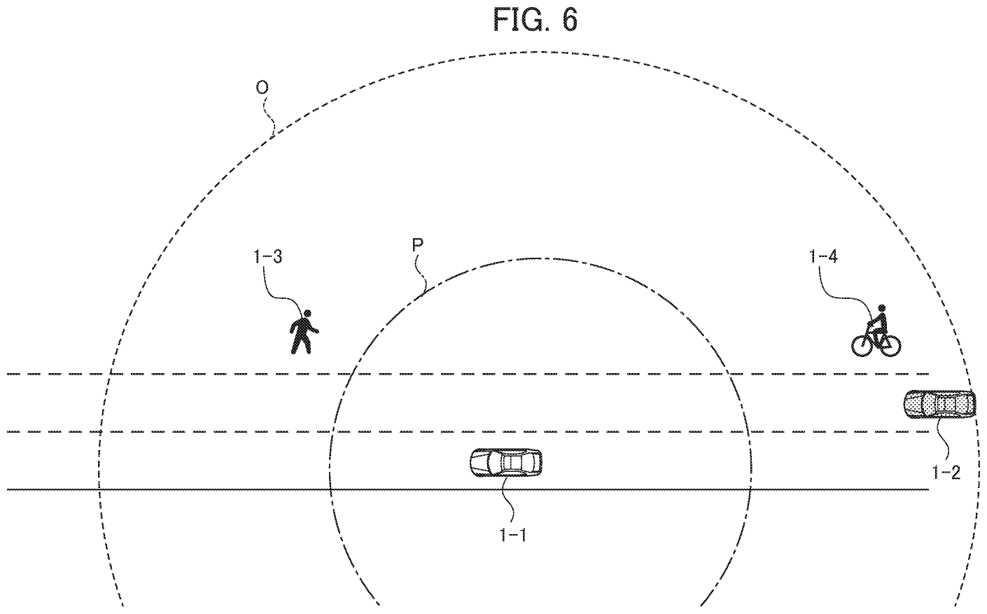

For example, in the above-described embodiment, information exchange is performed by inter-vehicle communication between the subject vehicle 1-1 and the other vehicle 1-2, but there is no limitation thereto. For example, as illustrated in FIG. 6, in addition to the subject vehicle 1-1 and the other vehicle 1-2, a person 1-3 or a light vehicle 1-4 such as bicycle may constitute the mobile body. FIG. 6 is a conceptual diagram illustrating a preparation region and a synchronization region based on time in a mobile-body information acquiring system according to a modification example of the embodiment of the invention.

Specifically, a moving person 1-3 or a moving light vehicle 1-4 may carry a terminal device such a smart phone that can perform calculation or sensing. In this case, an absolute movement speed of the person 1-3 or the light vehicle 1-4 is low, and thus the priority for carrying out information transmission and reception is set to be lower in comparison to the vehicle. In addition, in this case, classification into a plurality of layers may be performed in accordance with a difference in a speed or position sensor, and information transmission and reception may be performed between mobile bodies pertaining to different layers.

In addition, in the above-described embodiment, an arbitrary vehicle can be set as the subject vehicle 1-1 and the other vehicle 1-2, and position information or the like of the other side is reflected on an action of one side, but there is not limitation to this configuration. For example, the mobile-body information acquiring system may be configured so that the information is reflected on an action of at least one side between the subject vehicle 1-1 and the other vehicle 1-2, and the position information or the like of the subject vehicle 1-1 and the other vehicle 1-2 may be reflected on another second vehicle and the like other than the subject vehicle 1-1 and the other vehicle 1-2. In a case where the second other vehicle is included, time point synchronization at the time of transmission in the related art results in synchronization between two vehicles, and it is difficult to improve accuracy due to time deviation. However, the time becomes common due to the method and the system using the absolute time point according to the invention, and thus it is possible to secure the accuracy. In addition, the method of the invention is applicable to automatic driving in which a vehicle mainly performs control even in a driving operation (manual driving) by an occupant.

In addition, the definition time point (T, T1 to T4) transmitted by the communication unit 30 is a time point after predetermined time from the current time point (C), but there is no limitation thereto. For example, the definition time point (T, T1 to T4) transmitted by the communication unit 30 may be a time point after predetermined time from a transmission time point.

### EXPLANATION OF REFERENCE NUMERALS

1 VEHICLE
1-1 SUBJECT VEHICLE (FIRST MOBILE BODY)
1-2 ANOTHER VEHICLE (SECOND MOBILE BODY)
11 CALCULATION UNIT
20 MOVEMENT DEVICE
30 COMMUNICATION UNIT
111 PROCESSING UNIT
311 TRANSMISSION UNIT
312 RECEPTION UNIT
T, T1 to T4 DEFINITION TIME POINT

1. A mobile-body information acquiring system that exchanges information between mobile bodies including a movement unit for movement, a calculation unit that performs calculation relating to the movement, and a communication unit that moves in combination with the movement unit and performs communication of an output from the calculation unit as information,
wherein the calculation unit includes a processing unit that sets a time point or time at which a first mobile body desires to take an action about movement or a time point or time in the very near future which the first mobile body desires to know in relation to movement, and
the communication unit transmits information of the time point or the time which includes time point information expressed by an absolute time point.

2. The mobile-body information acquiring system according to claim 1,
wherein the time point or the time that is transmitted by the communication unit is a time point after predetermined time from a current time point or a transmission time point.

3. The mobile-body information acquiring system according to claim 1,
wherein the time point or the time that is set by the processing unit includes a plurality of time points or a plurality of kinds of time in the future which are closer to the present in comparison to a time point or time at which the first mobile body desires to take an action about movement, or a time point or time in the very near future which the first mobile body desires to know in relation to movement.

4. The mobile-body information acquiring system according to claim 3,
wherein the communication unit transmits information of at least two or more time points or two or more kinds of time among the plurality of time points or the plurality of kinds of time which are set through communication performed once.

5. A mobile-body information acquiring system that exchanges information between mobile bodies including a communication unit and a movement unit, comprising:
a reception unit that receives a time point or time at which a first mobile body desires to take an action about movement or a time point or time in the very near future which the first mobile body desires to know in relation to movement as information;
a calculation unit that calculates the information relating to movement of a second mobile body on the basis of the time point or time; and
a transmission unit that transmits information of a calculation result obtained by the calculation unit to the first mobile body,
wherein the information that is transmitted to the first mobile body includes time point information expressed by an absolute time point.

6. A mobile-body information acquiring method of exchanging information between mobile bodies including a movement unit for movement, a calculation unit that performs calculation relating to the movement, and
a communication unit that moves in combination with the movement unit and performs communication of an output from the calculation unit as information, comprising:
a process of setting a time point or time at which a first mobile body desires to take an action about movement or a time point or time in the very near future which the first mobile body desires to know in relation to movement by a processing unit provided in the calculation unit; and
a process of transmitting information of the time point or the time which includes time point information expressed by an absolute time point by the communication unit.

7. A program storage device readable by machine that causes mobile bodies to function as a mobile-body information acquiring apparatus that exchanges information between the mobile bodies including a movement unit for movement, a calculation unit that performs calculation relating to the movement, a communication unit that moves in combination with the movement unit and performs communication of an output from the calculation unit as information, and a computer that controls the movement unit, the calculation unit, and the communication unit,
wherein the calculation unit is caused to function as a processing unit that sets a time point or time at which a first mobile body desires to take an action about movement or a time point or time in the very near future which the first mobile body desires to know in relation to movement, and
the communication unit is caused to function to transmit information of the time point or the time which includes time point information expressed by an absolute time point.

8. A mobile body comprising:
a mobile-body information acquiring system that exchanges information between mobile bodies including a movement unit for movement, a calculation unit that performs calculation relating to the movement, and a communication unit that moves in combination with the movement unit and performs communication of an output from the calculation unit as information,
wherein the calculation unit includes a processing unit that sets a time point or time at which a first mobile body desires to take an action about movement or a time point or time in the very near future which the first mobile body desires to know in relation to movement, and
the communication unit transmits information of the time point or the time which includes time point information expressed by an absolute time point.
